(19) United States
(12) Patent Application Publication
(10) Pub. No.: US 2009/0224647 A1
(43) Pub. Date: Sep. 10, 2009

(54) ELECTRODES

(76) Inventors: David Steven Barratt, Blackburn (GB); Derek John Holden, Blackburn (GB)

Correspondence Address: TREGO, HINES & LADENHEIM, PLLC, 9300 HARRIS CORNERS PARKWAY, SUITE 210, CHARLOTTE, NC, 28269-3797, US

(21) Appl. No.: 12/094,113

(22) PCT Filed: Nov. 17, 2006
(86) PCT No.: PCT/GB06/04302

§ 371 Date: Sep. 5, 2008

(30) Foreign Application Priority Data
Nov. 18, 2005 (GB) 0523478.6

(51) Int. Cl. H01J 1/96; H01J 1/00; H01J 9/14; H01J 61/09

(52) U.S. Cl. 313/283; 313/356; 445/49

(57) ABSTRACT

There are provided electrode emission source components (105) and electrical apparatus comprising the same. In one embodiment an electrode emission source component comprises a tubular metal body (107) having first and second open ends (140, 150). Also provided are methods of forming electrode components.

### FIELD OF THE INVENTION

The present invention relates to electrodes, electrode components and apparatus comprising electrodes as well as to methods of manufacturing electrodes and electrode components.

### BACKGROUND TO THE INVENTION

There are known electrodes having a range of constructions and applications. Cold cathode electrodes for example have been found effective for lighting applications including cold cathode fluorescent lamps (CCFL) as backlights for LCD displays. However, such electrodes are of a small size and can thus be difficult to manufacture.

A known electrode comprises Molybdenum and has a tubular body which is blind at one end and to which end a stem (or pin) is attached. The tubular body is formed in a single part by a deep-drawing process and may consequently have a number of disadvantages.

The deep-drawing process can be inefficient resulting in wastage of materials and consequently increased manufacturing costs.

Additionally, with a deep drawing process the length of the tubular body may be restricted to a maximum of around 5 times its diameter. It may also be desirable to apply a coating to the inside of the body and this may be difficult.

A particular problem is that spluttering may occur and erode the wall of the electrode. Such erosion may create holes in the wall and be detrimental to the electrodes performance. Furthermore, erosion may eventually cause the tubular body to detach from the stem. Since, in use, the electrode is connected to a power supply and mounted to a housing via the stem this can render the electrode inoperative.

There thus remains a need for alternative electrodes and manufacturing methods.

Accordingly, the present invention aims to address at least one disadvantage associated with the prior art whether discussed herein or otherwise.

### SUMMARY OF INVENTION

According to a first aspect of the present invention there is provided an electrode emission source component comprising a tubular metal body having first and second open ends.

Suitably, an inner surface of the tubular body comprises an electron source.

Suitably, the electrode emission source component comprises mounting means for mounting the tubular body in a housing of an electrical apparatus, for example a cold cathode fluorescent lamp.

Suitably, the electrode emission source component comprises connector means for connecting the tubular body to a power supply.

The mounting means and connector means may be one and the same.

Suitably, the electrode component comprises connector/mounting means which are integral with or joined to a tube wall of the tubular body.

The component may comprise one or more stems which provide the connector/mounting means. Suitably the or each stem is connected to a tube wall of the tubular body. Suitably, the or each stem is welded to the tube wall.

Alternatively, the component may comprise one or more arms which form a longitudinal continuation of a part of a tube wall of the tubular body. An arm may thus correspond to a stem with the distinction being that it is formed integrally with a tube part of the tubular body.

The connector/mounting means may comprise a plurality of stems or arms in spaced apart arrangement around the tubular body.

Suitably, the or each stem/arm extends from the tubular body (or tube part thereof) adjacent its first open end.

Suitably, the or each stem or arm is arranged to extend in a direction substantially corresponding to the direction of the tubular body's longitudinal extent.

The mounting means of the electrode component may comprise a glass ring mounted on a stem/arm. The glass ring may provide an attachment point by which the electrode may be secured into a housing.

As an alternative to an arm or stem the mounting and/or connector means may comprise an arm and stem combination. For example a stem may be welded to an arm.

Alternatively, the component may comprise a tubular body arranged to mount directly to a housing of an electrical apparatus adjacent a first end thereof and/or connect directly to a power supply. Suitably, the body is arranged to extend through a wall of the housing.

The body may comprise an external glass ring provided adjacent its first end to allow it to be mounted to a glass housing of an electrical apparatus such as a lamp. The mounting means may thus comprise that part of the tubular body provided with the glass ring.

The connector means may comprise that part of the tubular body which lies external of the housing in use. The connector means may thus comprise a part of the tubular body lying between the extreme first end thereof and the glass ring.

In use, the tubular chamber within the body may be blocked adjacent its first end by a part of a wall of the housing. Alternatively the component may comprise a glass wall arranged to block the chamber within the metal body. Thus, in use, if a housing is sealed to the outside of the tubular body a sealed unit may be produced.

Thus, although the tubular body may be open at both ends the electrode component may be closed, suitably sealed, at one end.

Suitably, the connector/mounting means is arranged so as not to extend across the opening of the first end of the tubular body.

Suitably, the connector/mounting means is arranged so as not to lie within the tubular body or within any space which would lie within the tubular body if the tube were extended in the direction of its longitudinal extent.

The connector/mounting means may thus be arranged to avoid being eroded by the effects of spluttering.

Suitably, the tubular body has an outer diameter of between 0.5 and 5 mm.

Suitably, the tubular body has a length of between 1 and 20 times its diameter, preferably between 3 and 15 times its diameter, for example around 10 times its diameter.

Suitably, the length of the tubular body is at least 5 times its diameter, for example at least 6, 7, 8, 9, 10, 11 or 12 times its diameter.

Suitably, the tubular body comprises a tubular wall formed from a metal sheet.

The metal sheet of the tubular body may be rolled, folded or bent into a tubular configuration.

The tubular body may comprise a single tube. Suitably, the tube is cylindrical. The tube may have a substantially circular cross section. Alternatively, the tube may have any other suitable cross section, for example a square cross section.

The tube may comprise a single chamber. Alternatively the tube may be subdivided into a plurality of chambers. The tubular body may comprise an outer wall defining a tube and one or more inner walls which may subdivide the tube into longitudinally extending chambers. The inner walls may be formed integrally with the outer wall. For example, the tubular body may comprise a spiral wall. By incorporating inner walls the surface area available as an electron emission source may be increased.

Alternatively, or in addition, the tubular body may comprise a plurality of tubes. The tubular body may for example comprise one or more walls defining a plurality of tubes. Suitably, each tube is cylindrical and may have a circular or any other suitable cross section. Suitably, the tubes are joined such that they share a common mounting and/or connector means. For example, a tubular body may comprise two or more cylindrical tubes having independent tubular walls which are welded to a single stem.

The tubular body may comprise a plurality of concentric tubes. The electrode component may thus comprise a plurality of emission surfaces.

The electrode component may comprise an electrode component according to the third aspect.

The electrode component may comprise any feature as described in relation to the third aspect except where such features are mutually exclusive.

Suitably, the tubular body comprises a metal sheet which is folded, bent or rolled, preferably folded, to define a plurality of generally parallel extending tubes. Some of the two or more tubes may share common walls.

Suitably, the tubular body comprises a bent metal sheet which is substantially planar prior to being formed into the tubular body. Suitably, the tubular body comprises a bent metal sheet which is substantially rectangular prior to being formed into the tubular body.

The tubular body may comprise a single tube formed from a metal sheet and opposed first and second edges of the metal sheet may lie substantially adjacent one another when formed into the tube.

Suitably, first and second edge regions of the metal sheet overlap when formed into a single tube. The tube may thus have a double wall thickness at a seam which closes the tube circumferentially.

Suitably, first and second edge regions of the metal sheet overlap by between 0.1% and 10% of the circumference of the tube, when formed into a single tube, for example by between 0.5% and 8%.

Suitably, the metal sheet has a thickness of between 0.01 and 0.1 mm, preferably between 0.02 and 0.1 mm, for example around 0.08mm. The tubular body may thus have a wall having a thickness of between 0.01 and 1 mm, preferably between 0.02 and 0.1 mm, for example around 0.08 mm. The wall may have double this thickness where edges of the metal sheet overlap.

Suitably, the electrode component comprises one or more welds to secure the bent metal sheet in a tubular configuration.

Suitably, one or more welds are formed to join overlapping parts of the metal sheet. Suitably, overlapping parts of the metal sheet are laser welded together. Suitably, the welds are spot welds.

The component may comprise one or more stems and these may be secured to the tubular body by one or more welds. Suitably, the tubular body and the or each stem are laser welded together. Suitably, the welds are spot welds.

Alternatively, as described, the connector/mounting means may comprise the tubular body itself or an arm forming a continuation thereof.

Suitably, the tubular body comprises a metal sheet which comprises a pure metal. Alternatively, the tubular body may comprise a metal sheet which comprises an alloy.

Suitably, the metal sheet has a melting point of greater than 1100° C. Suitably, the metal sheet has a thermal conductivity of between 0.2 Watts/cm².° C. and 5.0 Watts/cm².° C. Suitably, the metal sheet has a coefficient of linear expansion of between 1×10⁻⁶/° C. and 30×10⁻⁶/° C. at ambient temperature.

Suitably, the tubular body comprises a metal sheet which comprises a transition metal. Suitably, the tubular body comprises a metal sheet which comprises a metal selected from the group consisting of Steel (ferrous) alloys such as Kovar, refractory metals such as Nickel (Ni), Molybdenum (Mo), Niobium (Nb), Tantalum (Ta) and Tungsten (W) or alloys and/or mixtures thereof. Suitably, the metal sheet comprises Molybdenum. Alternatively, the metal sheet may comprise Nickel which may be coated on at least one side.

Being an extension of the tubular body an arm, if present, may share the same composition and properties.

The electrode component may comprise a stem which may comprise a pure metal. Alternatively, the stem may comprise an alloy.

Suitably, stem has a melting point of greater than 1100° C. Suitably, the mounting means has a thermal conductivity of between 0.2 Watts/cm².° C. and 5.0 Watts/cm².° C. Suitably, the mounting means has a coefficient of linear expansion of between 1×10⁻⁶/° C. and 30×10⁻⁶/° C. at ambient temperature.

Suitably, the mounting means comprises a transition metal. Suitably, the mounting means comprises a metal selected from the group consisting of Steel (ferrous) alloys such as Kovar, Nickel (Ni), Molybdenum (Mo), Niobium (Nb), Tantalum (Ta) and Tungsten (W) or alloys and/or mixtures thereof. Suitably, the mounting means comprises Molybdenum.

Suitably, the stem and tubular body comprise the same metal. Alternatively, the stem and tubular may comprise distinct metals. The stem and tubular body may thus be made from distinct materials chosen for their specific properties and functional performance in the overall electrode component combination.

The inner face of the tubular body of the electrode component may comprise a surface coating.

Suitably, the tubular body comprises a metal sheet which is provided with a surface coating on a first side and then formed into a tube such that said first side forms the inner face of the tube. Thus, it may be possible to form a tubular body having a tube of substantial length which is coated substantially evenly over its inner extent.

The surface coating may be arranged to improve the performance and/or lifespan of the electrode component.

The surface coating may have a thickness of between 0.001 mm and 0.1 mm.

The surface coating may comprise micro and/or nano sized particles to increase the surface area of the electrode component. This may result in higher brightness and/or lower operating temperatures for lamps employing electrodes comprising the electrode emission source component.

The surface coating may comprise a material having a low work function and/or high resistance to ion bombardment. The surface coating may for example comprise diamond or polycrystalline silicon.

The surface coating may comprise a metal which has a higher activity than the metal forming the component that it coats. A metal having a higher activity may have an increased resistance to ion bombardment and/or improved electron emission properties which may be due to the metal having a lower work function and/or higher electrical conductivity. The surface coating may comprise Molybdenum or Tungsten or Barium-Aluminium alloys or other suitable elements or alloys. The electrode emission source component may thus be constructed from a tubular body comprising a base metal, such as Nickel, coated with a more active but more expensive metal, such as Molybdenum or Tungsten or Barium-Aluminium alloy. This may allow effective electrodes to be manufactured more economically.

The active coating material may comprise an alloy comprising Mercury. Suitably, the active material comprises an alloy comprising Barium, for example Barium-Aluminium, and Mercury. The active material may comprise a Ba—Al and Hg alloy. The inclusion of Mercury may, in use, counteract difficulties associated with the removal of Mercury (Hg) vapour within a lamp by reaction with Barium (Ba). Thus, the use of such an alloy may improve lamp brightness and/or efficiency.

The outer face of the electrode component may comprise a surface coating.

The tube may comprise a metal sheet which is provided with a surface coating on a second side and then formed into a tube such that said second side forms the outer face of the tube.

The surface coating may be arranged to improve the performance and/or lifespan of the electrode component.

The surface coating may comprise a coating as described in relation to the inner face of the electrode component.

The surface coating applied to the outer face may be the same as that applied to the inner face or may be distinct there from. Thus, a surface coating applied to the second side of the metal sheet may be the same as that applied to a first side of the metal sheet or may be distinct there from.

A surface coating may be applied to a part of the electrode component by a number of known methods, for example any of sputter coating, electrochemical deposition, metal-organic vapour phase deposition, in-situ precipitation, sol-gel processes, spraying, brushing or coil coating may be suitable.

Suitably, the surface coating comprises a metal which has a higher activity than the metal forming the component part that it coats.

Once the coating is applied it may be necessary to convert it to a suitable metallic form by a thermal and/or chemical treatment before the part of the electrode component is employed to manufacture the electrode component.

The tube may comprise a metal sheet which is provided with a surface coating which is then converted into a suitable metallic form prior to the metal sheet being formed into a tube.

Suitably, the electrode component comprises an electrode and may be arranged to be connected to a power supply and/or into an electrical apparatus.

According to a second aspect of the present invention there is provided a method of forming an electrode component according to the first aspect, wherein the method comprises forming a tubular body from a metal sheet such that the tubular body is open at both first and second ends and providing the component with mounting and connector means to mount to a housing of an electrical apparatus and connect to a power supply.

The method may comprise attaching a stem to the tubular body. The method may comprise providing the stem with a glass ring. The stem may thus comprise the connector and mounting means.

Alternatively, the method may comprise forming a tubular body having an arm extending therefrom. The method may comprise providing the arm with a glass ring. The arm may thus comprise the connector and mounting means.

Alternatively, the method may comprise providing a glass ring to the tubular body. Part of the tubular body may thus comprise the connector and mounting means.

The method may comprise wrapping a metal sheet around a forming member such that the metal sheet adopts a tubular configuration substantially corresponding to the outer face of the forming member.

The metal sheet may be wrapped around a forming member by a plurality of form fingers. The form fingers may press the metal sheet against the forming member to form the tube.

The metal sheet may be such that once formed into the tubular configuration it substantially retains said configuration.

Suitably, the method comprises the step of securing the metal sheet in the tubular configuration. Said securement step may comprise welding edges of the metal sheet together in the tubular configuration.

The method may further comprise a method of manufacturing an electrical apparatus according to the second aspect.

The method may comprise sealing all or part of an electrode component within a housing.

According to a third aspect of the present invention there is provided an electrode emission source component comprising a plurality of internal emission surfaces.

Suitably, each internal metal surface of the emission source component comprises an electron source.

Suitably, the electrode emission source component comprises an outer metal tube, said tube having an inner surface which is an emission surface, and one or more emission parts internal of the tube, the or each emission part providing one or more further emission surfaces.

Suitably, the or each emission part comprises a metal tube or partial tube. By partial tube it is meant a tube having apertures therein or a slot therein. In the case of a partial tube having a slot, the slot may extend the length of the partial tube such that it is not annular at any point.

Suitably, where the emission part or parts comprise tubes or partial tubes, both the inner and outer surface(s) of the tube(s) comprise emission surfaces.

Suitably, the electrode emission source component comprises a tubular metal body having first and second ends wherein the second is open. The electrode emission source component may comprise a tubular metal body having first and second open ends.

Suitably, the electrode emission source component comprises a tubular metal body comprising a plurality of tubes.

Suitably, the electrode emission source component comprises a plurality of metal tubes which may be generally parallel extending.

Suitably, each tube is substantially cylindrical and may have a circular or any other suitable cross section.

The tubes may each have differing diameters such that the smaller can locate within the larger.

Suitably, the tubes are arranged within one another. Suitably, the tubes are concentric.

The outer diameter of the innermost tube is suitably between 0.5 mm and 5 mm. Suitably, the outer diameter of the outermost tube is between 2 mm and 25 mm.

The spacing between the tubes is suitably between 0.5 mm and 5 mm.

Suitably, the tubes have a length of between 5 mm and 30 mm. the tubes may have the same or differing lengths. Suitably, the tubes all have substantially the same length.

Suitably, the inner surface of each tube is an emission surface. Suitably, the tubes are arranged within one another such that the outer surface of all but the outer most tube is an emission surface.

Suitably, the electrode emission source component comprises a first metal tube and a second metal tube located within the chamber defined by the first tube. Suitably, said first and second tubes are concentric.

The electrode emission source component may comprise a third metal tube located within the chamber defined by the second tube. Suitably, said second and third tubes are concentric.

Suitably, each tube has a first and second end and is open at its second end. Each tube may be open at its first end. Alternatively, the tubes may be closed or partially closed at their first ends.

Suitably, the electrode emission source component comprises one or more walls, suitably two or more, defining a plurality of tubes.

Suitably, the or each tube comprises a tubular wall formed from a metal sheet. The metal sheet may be folded, bent or rolled, preferably folded, to define a tube.

Suitably, the electrode emission source component comprises mounting means for mounting the component in a housing of an electrical apparatus, for example a cold cathode fluorescent lamp.

Suitably, the electrode emission source component comprises connector means for connecting the component to a power supply.

The mounting means and connector means may be one and the same.

Suitably, the electrode emission source component comprises first and second ends with the mounting and connector means located at or towards the first end. Suitably, the electrode emission source component comprises a plurality of tubes each having their first end at the first end of the component.

Suitably, the electrode emission source component comprises tubes linked such that they share a common mounting and/or connector means. For example, a tubular body may comprise two or more co-axial cylindrical tubes having independent tubular walls which are linked to one another.

The tubes are suitably connected to one another by link means. Suitably, the link means comprises a glass wall or walls, suitably a glass ring, interposing adjacent tubes. Suitably the link means is located at or towards a first end of the tubes.

Alternatively, or in addition, the link means may comprise a metal connector or connectors joining adjacent tubes.

The tubes may comprise connecting arms which pass through a glass preform and are sealed in place relative thereto. In use, the tubes and glass preform may be sealed into a glass housing. A single bus bar may be welded to the protruding arms (tabs). The link means may thus comprise both the perform and bus bar. Alternatively, each arm (tab) may have its own connection to a power source and the link means may simply comprise the preform.

The link means may comprise a metal plate connected, suitably welded, to the first end of the tubes. The metal plate may have one or more stems extending from it for passing through the glass wall of a housing and connecting to a power supply. Alternatively, the plate may be welded to one or more connecting wires which themselves act as feedthroughs and are sealed in a glass base. The later may make the manufacture compatible with known Hot Cathode Fluorescent Lamp (HCFL) manufacturing technology. Alternatively, the plate may pass through the glass wall of a housing and may thus comprise the mounting means. Alternatively, the tubes may pass through the glass wall of a housing such that the plate lies external of the housing and the outer tube may thus comprise the mounting means.

The link means may alternatively, or additionally, comprise one or more connecting rods linking adjacent tubes. A rod or rods may be located at or towards the first end of the tubes. Alternatively, or in addition, a rod or rods may be located at or towards a second end of the tubes.

Suitably the plate and/or rod or rods are made of the same material as the tubes. Alternatively the plate and/or rod or rods may be made of a differing material to the tubes provided it has sufficient mechanical strength to hold the tubes in place and sufficient electrical conductivity for the electrode to function.

Suitably, the tubular chambers defined within the electrode emission source component are sealed at or towards the components first end. Suitably, the chambers are sealed by a glass wall or walls, which may comprise link means. Thus, in use, if a housing is sealed to the outside of the electrode emission source component a sealed unit may be produced.

The tubes may be linked by glass links such that, in use, there is no metal connection between the tubes lying internal to a housing into which the electrode emission source component is sealed.

Suitably, the electrode component comprises connector/mounting means which are integral with or joined to a tube wall of a tube.

The component may comprise one or more stems which provide the connector/mounting means. Suitably the or each stem is connected to a tube wall of a tube. Suitably, the or each stem is welded to the tube wall.

Alternatively, the component may comprise one or more arms which form a longitudinal continuation of a part of a tube wall of a tube. An arm may thus correspond to a stem with the distinction being that it is formed integrally with a tube part of the tube.

The connector/mounting means may comprise a plurality of stems or arms in spaced apart arrangement around the component.

Suitably, the or each stem/arm extends from the tubes at the components first open end.

Suitably, the or each stem or arm is arranged to extend in a direction substantially corresponding to the direction of the tubes longitudinal extent.

The mounting means of the electrode component may comprise a glass ring mounted on a stem/arm. The glass ring may provide an attachment point by which the component may be secured into a housing.

As an alternative to an arm or stem the mounting and/or connector means may comprise an arm and stem combination. For example a stem may be welded to an arm.

As a further alternative to an arm or stem the mounting and/or connector means may comprise a base plate located at a first end of the tubes. The plate may be sealed into a glass housing such that the tubes lie internal of the housing and the plate passes through the housing.

Alternatively, the component may comprise a component having a tube or tubes arranged to mount directly to a housing of an electrical apparatus adjacent a first end thereof and/or connect directly to a power supply. A tube may be arranged to extend through a wall of the housing.

A tube, suitably the outer tube, may comprise an external glass ring provided adjacent its first end to allow it to be mounted to a glass housing of an electrical apparatus such as a lamp. The mounting means may thus comprise that part of the component provided with the glass ring.

The connector means may comprise that part of the component which lies external of the housing in use. The connector means may thus comprise a part of the component lying between the extreme first end thereof and the glass ring.

Suitably, the electrode component comprises an electrode and may be arranged to be connected to a power supply and/or into an electrical apparatus.

The electrode emission source component may comprise a component according to the first aspect.

The electrode emission source component may comprise any feature as described in relation to the first aspect except where such features are mutually exclusive.

According to a fourth aspect of the present invention there is provided a method of forming an electrode component according to the third aspect, wherein the method comprises: forming a tube from a metal sheet to provide an outer metal tube, said tube having an inner surface which is an emission surface; locating one or more emission parts internal of the tube, the or each emission part providing one or more further emission surfaces; and linking the outer tube to the emission parts.

The method may comprise any feature as described in relation to the third aspect except where such features are mutually exclusive.

According to a fifth aspect of the present invention there is provided an electrical apparatus comprising an electrode component according to the first and/or second aspects.

The electrical apparatus may comprise a lighting apparatus. The electrical apparatus may for example comprise a cold-cathode fluorescent lamp, used for example in a back light for an LCD display.

Suitably, the electrical apparatus comprises a housing and an electrode component according to the first and/or third aspect.

Suitably, the electrical apparatus comprises a lamp. Suitably, the housing comprises a glass housing.

Suitably, all or part of the electrode component is sealed within the housing.

The electrical apparatus may comprise an electrode component according to the first aspect.

The electrical apparatus may comprises an electrode component having connector/mounting means comprising a stem or arm and a stem/arm of the electrode assembly may pass through a wall of the housing and be secured thereto such that the tubular body lies within the housing. The apparatus may thus be arranged such that it can be connected to a power supply by a stem/arm.

Alternatively, the electrical apparatus may comprise an electrode component having connector/mounting means provided by the tubular body itself and part of the tubular body passes through a wall of the housing and is secured thereto such that part of the tubular body lies within the housing and part lies external thereto. The apparatus may thus be arranged such that it can be connected to a power supply by the part of the tubular wall external to the housing. The electrical apparatus may thus comprise a stemless electrode.

The electrical apparatus may comprise an electrode component according to the third aspect.

The electrical apparatus may comprise an electrode component comprising a plurality of tubes arranged within one another and the connector/mounting means provided may be provide by one of the tubes itself, suitably the outermost tube, with part of a tube, suitably each tube, passing through a wall of the housing and being secured thereto such that part of a tube, suitably each tube lies within the housing and part lies external thereto. The electrical apparatus may thus comprise a stemless electrode.

Alternatively, the electrical apparatus may comprise an electrode component comprising a base plate connected to the first end of the tubes and having a stem or wires extending therefrom passing through the housing of the electrical apparatus.

The electrical apparatus may comprise any feature as described in relation to the second or fourth aspects except where such features are mutually exclusive.

According to a sixth aspect of the present invention there is provided an electrical apparatus comprising a glass housing and an electrode emission source component, wherein said component comprises a metal body defining a chamber having an emission surface, wherein the body has first and second ends with an opening to the chamber at the second end and wherein the body passes through the housing and is sealed thereto such that the second end of the body is located within a sealed housing chamber and the first end of the body is external to the housing.

Surprisingly, it has been found that locating part of the electrode emission source component to lie external of the housing may improve performance. With this arrangement there may be greater transfer of heat away from the component and reduced sputtering.

Suitably, the electrical apparatus comprises a lamp.

Suitably, the body comprises a tubular section. Suitably, the chamber opening is provided by an end of the tubular section.

Suitably, the body comprises a tubular body which defines a chamber and has first and second ends, with the second end of the tubular body being open and with the chamber being sealed at the tubular bodies first end or at a point between the tubular bodies first and second ends. The tubular body may comprise a tube.

Suitably, the body comprises a tubular body which is blind at its first end. Suitably, the second, open end of the tubular body comprises the chamber opening.

Suitably, the body comprises a tube wall and a base wall.

The tube wall and base wall may be integral. The body may for example comprise a tubular body which is blind at one end and formed by a deep-drawing process.

Alternatively, the tube wall and base wall may be welded to one another. The body may for example comprise an open ended tube welded to a base plate or to a cap which closes a first end of the tube. Where the component comprises a cap or base plate these may comprise cheaper materials than the tube.

Suitably, the electrical apparatus comprises an electrode emission source component sealed to a housing to provide a sealed housing chamber. The internal environment of the housing chamber may thus be sealed from the exterior of the housing.

Suitably, the electrode emission source component is mounted to the housing such that the seal of the housing chamber does not include any metal-metal welds. Thus, where the body comprises a base member, such as a plate, or cap the base member or cap may be sealed to the housing.

The electrical apparatus may comprise a heat sink. The heat sink is suitably located external to the housing but may be located partially internally. The heat sink may comprise part of the electrode emission source component. For example the component may comprise a base member, for example a plate, or cap having thick walls. Alternatively, the heat sink may comprise a conductive material in contact with an external part of the component.

The electrical apparatus may comprise a clip connector for forming an electrical connection to the electrode emission source component. This may aid assembly of the apparatus.

The electrical apparatus may comprise an electrode emission source component according to the first or third aspect.

The electrical apparatus may comprise an electrical apparatus according to the fifth aspect.

The electrical apparatus may comprise any feature as described in relation to any of the first, second, third, fourth, fifth or seventh aspects except where such features are mutually exclusive.

According to a seventh aspect of the present -invention there is provided an electrical apparatus comprising a glass housing and an electrode emission source component, wherein said component comprises a metal tube having an inner surface which is an emission surface and wherein the tube defines a chamber and has first and second ends, with the second end being open and the chamber being sealed at the tubes first end or at a point between the tubes first and second ends, and wherein the tube passes through the housing and is sealed thereto.

Suitably, the chamber is sealed at or towards the tubes first end.

The electrical apparatus may comprise an electrode emission source component according to the first or third aspect.

The electrical apparatus may comprise an electrical apparatus according to the fifth aspect.

The electrical apparatus may comprise an electrical apparatus according to the sixth aspect.

The electrical apparatus may comprise any feature as described in relation to any of the first, second, third, fourth, fifth or sixth aspects except where such features are mutually exclusive.

The electrode emission source component may comprise a tube having a cap or plug at its first end. Suitably, the cap or plug lies external of the housing. A glass disc may be provided in the tube so that the cap or plug is not in contact with the internal environment of the housing.

### BRIEF DESCRIPTION OF THE DRAWINGS

The present invention will now be illustrated by way of example with reference to the accompanying drawings in which:

FIG. 1 is a cross section of a cold-cathode fluorescent lamp comprising an electrode component

FIG. 2 is a cross section of a cold-cathode fluorescent lamp comprising an alternative embodiment of an electrode component; and

FIG. 3 illustrates end views of alternative embodiments of electrode components.

FIG. 4 illustrates end views of alternative embodiments of electrode components.

FIG. 5 illustrates cross sections of parts of cold cathode fluorescent lamps including the electrode components of FIG. 4.

### DESCRIPTION OF THE PREFERRED EMBODIMENTS

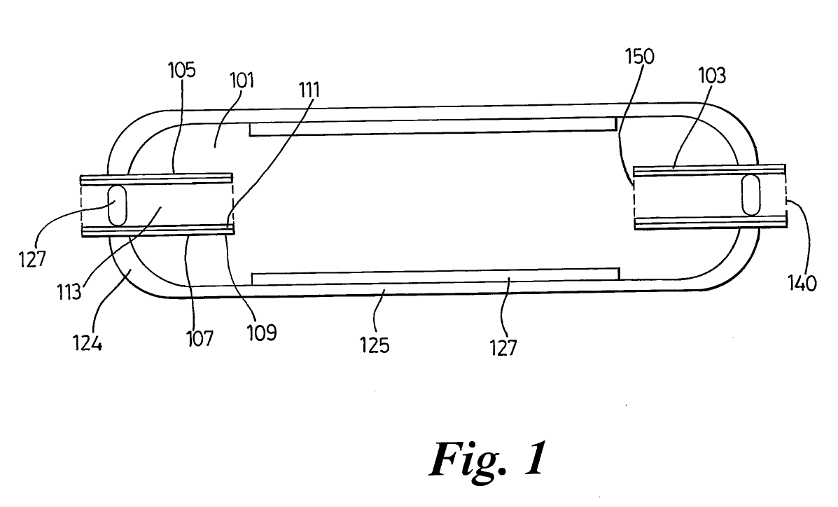

FIG. 1 illustrates a cold cathode fluorescent lamp 101 comprising electrodes 103 at opposed ends and each of which comprises electrode emission source components 105.

The electrode component 105 comprises an open ended tubular body 107 provided by a tubular wall 109. This body has first and second open ends 140, 150.

The tubular body 107 comprises a single tube formed by folding a rectangular metal sheet around a forming member such that edges of the sheet overlap. The overlapping edges are then joined with a number of laser spot welds to secure the sheet in a tubular configuration.

The tubular wall 109 comprises Kovar (steel alloy) as a base material and is provided with an active material coating layer 111 of Barium-Aluminium alloy on its inner surface.

The lamp 101 is such that the electrodes 103 thereof consist of a tubular body 107 and thus comprise stemless electrodes. The tubular wall 109 passes through the wall 124 of a glass housing 125 of the lamp such that part of the body 107 lies internal of the housing 125 and a part, including the first end 140, lies external to the housing 125. The external part of the wall 109 is connected to a power supply (not shown). Internal of the tubular body 107 is a glass wall 127 which closes the chamber 113 defined by the tubular body 107 and seals the interior of the housing 125 from the exterior. The wall 209 of the body 207 thus provides mounting and connector means of the electrode component for mounting the component to a housing and connecting to a power supply.

The interior of the glass housing 125 is provided with a phosphor coating 127 and the housing 125 is evacuated and charged with a small quantity of mercury.

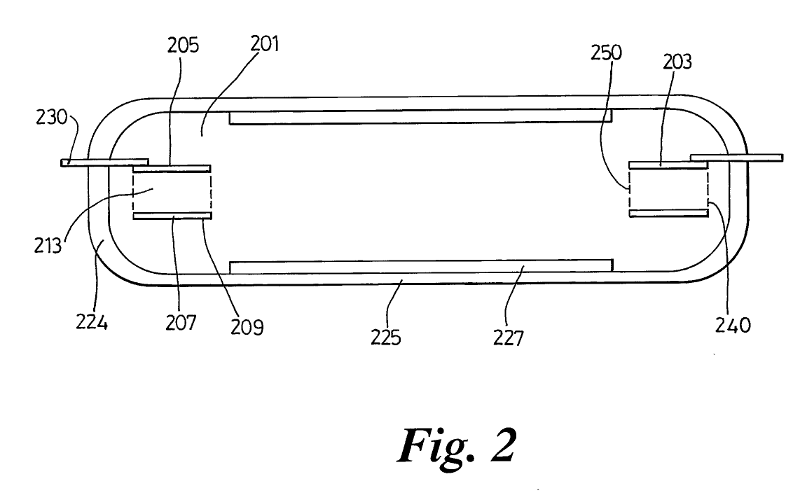

FIG. 2 illustrates an alternative embodiment of a cold cathode fluorescent lamp 201 comprising electrodes 203 at opposed ends and each of which comprises electrode emission source components 205.

The lamp 201 corresponds generally to that of FIG. 1. Again, it comprises a tubular body 207 having first and second open ends 240, 250. One distinction is that each electrode emission source component 205 comprises a Molybdenum tubular body 207 which is not coated. Another distinction is that the apparatus comprises a stem 230 which provides the mounting and connector means.

The stem 230 comprise Kovar (steel alloy) and is welded to the tubular wall 209 of the tubular body 207 adjacent its first end 240 such that it extends in substantially the same direction as the tubular body's longitudinal extent.

The stem 230 passes through a wall 224 of the housing 225 of the lamp 201 such that the stem 230 is mounted to the housing 225 with the tubular body 207 located internal to the housing 225. That part of the stem 230 lying external to the housing is connected to a power supply (not shown).

As with the embodiment of FIG. 1 the interior of the glass housing 125 is provided with a phosphor coating 127 and the housing 125 is evacuated and charged with a small quantity of mercury.

In both cases no part of the mounting/connector means extends across the first opening 140, 240 and thus damage caused thereto by spluttering may be minimal. The electrode component may thus have a substantial lifespan.

In an alternative embodiment(not illustrated) a lamp is substantially the same as that of the embodiment of FIG. 2 but the stem is replaced by an arm which comprises a continuation of a part of the tubular wall of the tubular body.

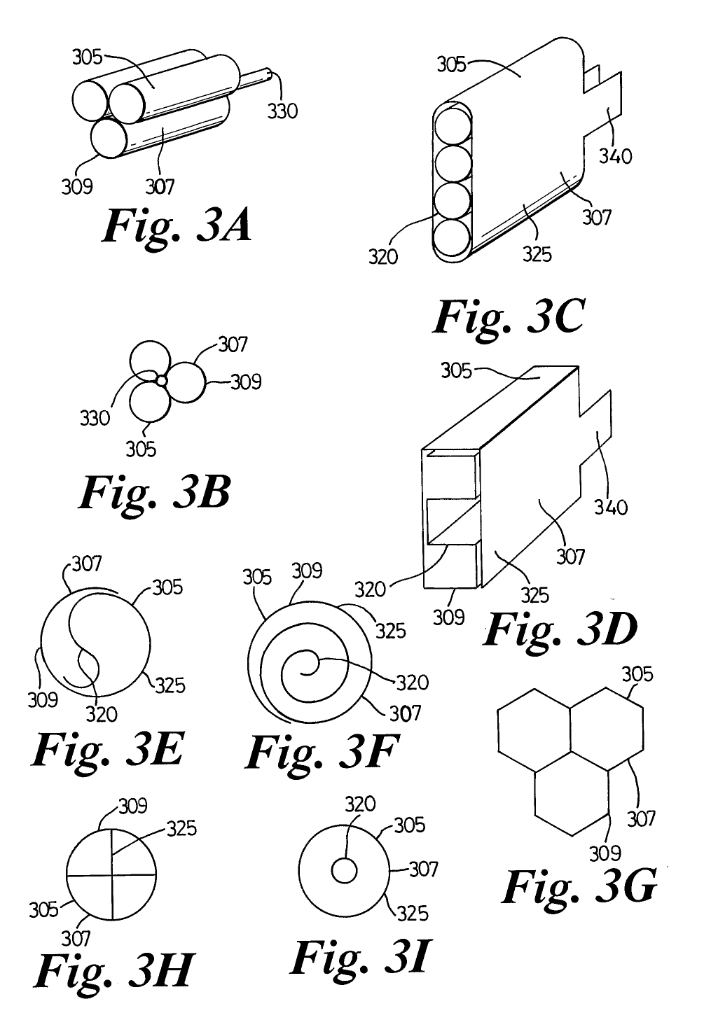

FIGS. 3A-3I illustrate alternative embodiments of electrode components. As the key elements of these components are the same as one another they are labelled accordingly.

FIGS. 3A and 3B are perspective and end views respectively of an electrode emission source component 305 which comprises a tubular body 307 comprising three tubes each defined by separate tubular walls 309. The tubular walls 309 are connected to a stem 330 which provides connector and mounting means of the component.

FIG. 3C is a perspective view of an electrode emission source component 305 which comprises a tubular body 307 comprising four tubes each defined by separate inner tubular walls 320 and encased by an outer tubular wall 325. The outer tubular wall 325 comprises two arms 340 extending therefrom which provide: connector and mounting means of the component.

FIG. 3D is a perspective view of an electrode emission source component 305 which comprises a tubular body 307 comprising three chambers defined by a tubular wall 309. Wall 309 is folded such that it has inner and outer parts 320, 325. Extending from an outer part 325 of the wall 309 is an arm 340 which provides connector and mounting means of the component.

FIG. 3E is an end view of an electrode emission source component 305 which comprises a tubular body 307 comprising two chambers defined by a tubular wall 309. Wall 309 is folded such that it has an “S” shaped inner part 320 and a circular outer part 325. Attached to an outer part of the wall 309 is a stem (not shown) which provides connector and mounting means of the component.

FIG. 3F is an end view of an electrode emission source component 305 which comprises a tubular body 307 comprising two chambers defined by a tubular wall 309. Wall 309 is folded such that it has a spiral inner part 320 and a circular outer part 325. Attached to an outer part of the wall 309 is a stem (not shown) which provides connector and mounting means of the component.

FIG. 3G is an end view of an electrode emission source component 305 which comprises a tubular body 307 comprising three conjoined hexagonal tubes each having a tubular wall 309. Attached centrally to the tubes is a stem (not shown) which provides connector and mounting means of the component.

FIG. 3H is an end view of an electrode, emission source component 305 which comprises a tubular body 307 comprising four chambers. The component comprises an outer tubular wall 309 which defines a tube and the tube is subdivided by an inner cross shaped wall 325. Attached to the wall 309 is a stem (not shown) which provides connector and mounting means of the component.

FIG. 3I is an end view of an electrode emission source component 305 which comprises a tubular body 307 comprising two chambers. The component comprises an outer tubular wall 325 and a concentric inner tubular wall 320 with one chamber defined inside the inner wall 320 and the other defined between the inner and outer walls 320, 325. Separate stems (not shown) are attached to each wall and provide connector and mounting means of the component.

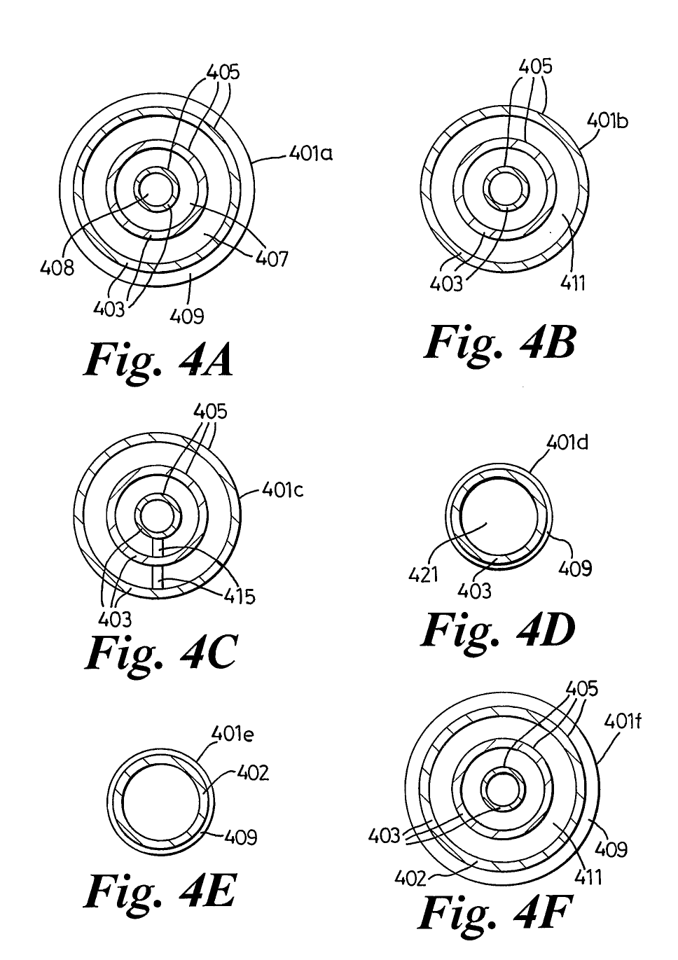

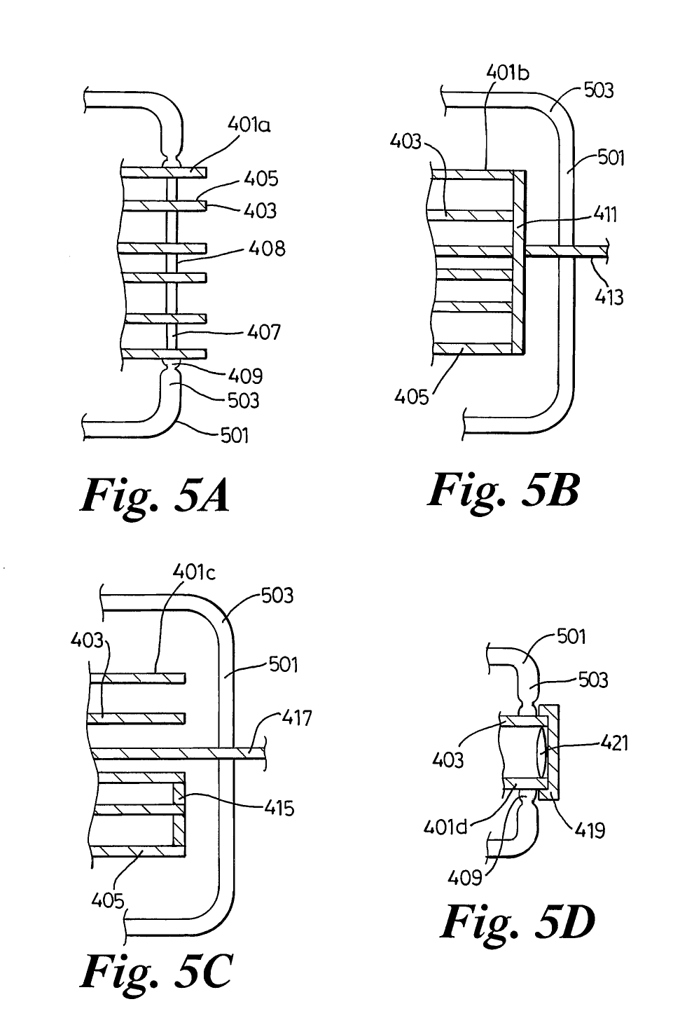

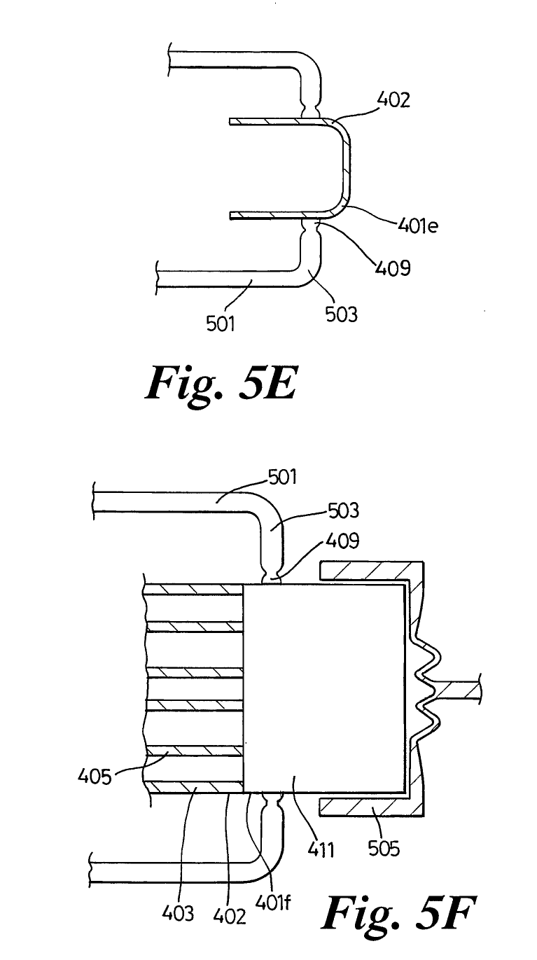

FIGS. 4A-4F illustrate alternative embodiments of electrode components. FIGS. 5A-5F show those components sealed into a housing of a cold cathode fluorescent lamp.

As the key elements of these components are the same as one another they are labelled accordingly.

FIG. 4A is an end view of an electrode emission source component 401a which comprises a plurality of concentric tubes 403 each defined by separate tubular walls 405. The tubes 405 are linked by link means comprising glass rings 407 at a first end of the tubes. The outermost tube is provided with a glass ring 409 for sealing it into a housing of a cold cathode fluorescent lamp. The innermost ring has a glass wall 408 in the form of a disc sealing the tube at its first end.

As shown by FIG. 5A the component 401a passes through the glass wall 503 of a housing 501 with the glass ring 409 being fused to the wall 501 to form a seal. Wall 503 is aligned with the glass rings 407 of the component 401a the parts of the tubes 403 lying external of the housing 501 provide connector means by which the electrode can be connected to a power supply.

FIGS. 4B and 5B show an alternative embodiment in which the electrode emission source component 401b comprises a plurality of concentric tubes 403 each defined by separate tubular walls 405. The tubes 405 are linked by link means comprising a metal base plate 411 welded to first ends of the tubes. Extending from the base plate 411 is a stem 413. As shown by FIG. 5B the stem extends through housing 501 for connection to a power supply.

In an alternative embodiment, not shown, the stem is replaced by a connector wire which passes through the housing and provides a feedthrough.

FIGS. 4C and 5C show an alternative embodiment in which the electrode emission source component 401c comprises a plurality of concentric tubes 403 each comprising separate tubular walls 405. The tubes 405 are linked by link means comprising metal rods 415 welded at a first end of the tubes. One of the tubes comprises an arm 417 extending through housing 501 to provide an electrical connection and mount the component relative to the housing.

FIGS. 4D and 5D show an alternative embodiment of an electrode emission source component 401d comprising a single tube 403. The component further comprise an end cap 419 closing the first end of the tube 403. Located adjacent the end cap 419 is a glass disc 421 to seal the end cap from the internal environment of the housing 501. The tube 403 is provided with an external glass ring 409 which is fused to the housing 501 wall 503 to seal it in place. The tube is connected to a power supply via end cap 419. Thus internally of the housing the electrode component may comprise an open ended metal tube, there being no closure internal of the housing.

FIGS. 4E and 5E show an alternative embodiment of an electrode emission source component 401e comprising a deep-drawn tubular body 402. The body 402 is provided with a glass ring 409 which is fused to the housing 501 wall 503 to seal it in place. The body 402 is connected to a power supply by the part lying external to the housing 501.

FIGS. 4F and 5F show an alternative embodiment of an electrode emission source component 401f comprising a tubular body 402 comprising tubes 403 and metal base plate 411 welded thereto. Each tube 403 comprises a separate tubular walls 405 and the base plate 411 provides link means linking the tubes 403. The base plate 411 is provided with a glass ring 409 which is fused to the housing 501 wall 503 to seal it in place and form a lamp. The plate 411 is connected to a power supply by a clip connector 505 which also mounts the lamp in position relative to the remainder of an electrical appliance (not shown).

The base plate 411 comprises a thick wall and the majority of the plate 411 lies external of the housing 501 such that the base plate 411 doubles as a heat sink. In use, heat is conducted away from the tubes 403 to the base plate 411 and is thus conducted out of the sealed chamber defined by the lamp housing 501.

It will be appreciated that electrode components according to preferred embodiments of the present invention may be advantageous. In particular, they may be efficient to produce and may have enhanced lifetimes compared to known components.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An electrode emission source component comprising a tubular metal body having first and second open ends.

2. A component according to claim 1, wherein the component comprises mounting means for mounting a tubular body in a housing of an electrical apparatus.

3. A component according to claim 1, wherein the component comprises connector means for connecting the tubular body to a power supply.

4. A component according to claim 2, wherein the mounting means and/or connector means comprises one or more sterns connected to a tubular wall of the tubular body.

5. A component according to claim 2, wherein the mounting means and/or connector means comprises one or more arms which form a longitudinal continuation of a part of a tube wall of the tubular body.

6. A component according to claim 2, wherein the component comprises a tubular body arranged to mount directly to a housing of an electrical apparatus adjacent a first end thereof and/or connect directly to a power supply.

7. A component according to claim 1, wherein
the tubular body has an outer diameter of between 0.5 and 5 mm.

8. A component according to claim 1, wherein the length of the tubular body at least 5 times its diameter.

9. A component according to claim 1 wherein
the tubular body comprises a tubular wall formed from a metal sheet.

10. A component according to claim 9, wherein the component comprises one or more welds to secure the metal sheet in a tubular configuration.

11. A component according to claim 1, wherein
the tube comprises a metal sheet which comprises a pure metal.

12. A component according to claim 1, wherein
the tubular body comprises a metal sheet which comprises an alloy.

13. A component according to claim 1, wherein
the tubular body comprises a metal sheet which comprises a metal selected from the group consisting of Steel (ferrous) alloys, Nickel (Ni), Molybdenum (Mo), Niobium (Nb), Tantalum (Ta) and Tungsten (W) and alloys thereof and mixtures thereof.

14. A component according to claim 1, wherein
the inner face of the electrode component comprises a surface coating.

15. A component according to claim 14, wherein the tubular body comprises a metal sheet which is provided with a surface coating on a first side and then formed into a tube such that said first side forms the inner face of the tube.

16. A component according to claim 14, wherein the surface coating comprises a metal which has a higher activity than the metal forming the component part that it coats.

17. A component according to claim 1, wherein the tube comprises a single chamber.

18. A component according to claim 1, wherein the tube is subdivided into a plurality of chambers.

19. A component according to claim 1, wherein the body comprises a plurality of tubes.

20. A component according claim 1, wherein
the component comprises a plurality of internal emission surfaces.

21. An electrode emission source component comprising a plurality of internal emission surfaces.

22. A component according to claim 21, wherein the electrode emission source component comprises an outer metal tube, said tube having an inner surface which is an emission surface, and one or more emission parts internal of the tube, the or each emission part providing one or more further emission surfaces.

23. A component according to claim 22, wherein the or each emission part comprises a metal tube or partial tube.

24. A component according to claim 1, wherein the component comprises tubes linked such that they share a common mounting and/or connector means.

25. (canceled)

26. An electrical apparatus comprising an electrode component according to claim 1.

27. An electrical apparatus according to claim 26, wherein the apparatus comprises a housing.

28. An electrical apparatus comprising a glass housing and an electrode emission source component, wherein said component comprises a metal body defining a chamber having an emission surface, wherein the body has first and second ends with an opening to the chamber at the second end and wherein the body passes through the housing and is sealed thereto such that the second end of the body is located within a sealed housing chamber and the first end of the body is external to the housing.

29. (canceled)

30. An electrical apparatus comprising a glass housing and an electrode emission source component, wherein said component comprises a metal tube having an inner surface which is an emission surface and wherein the tube defines a chamber and has first and second ends, with the second end being open and the chamber being sealed at the tubes first end or at a point between the tubes first and second ends, and wherein the tube passes through the housing and is sealed thereto.

31. An electrical apparatus according to claim 28, wherein the apparatus comprises a lamp.

32. (canceled)

33. A method of forming an electrode component according to claim 1, wherein the method comprises forming a tubular body from a metal sheet such that the tubular body is open at both first and second ends and providing the component with mounting and connector means to mount to a housing of an electrical apparatus and connect to a power supply.

34. A method of forming an electrode component according to claim 20, wherein the method comprises: forming a tube from a metal sheet to provide an outer metal tube, said tube having an inner surface which is an emission surface i locating one or more emission parts internal of the tube, the or each emission part providing one or more further emission surfaces, and linking the outer tube to the emission parts.

35. (canceled)
